(19) United States
(12) Patent Application Publication
(10) Pub. No.: US 2007/0127400 A1
(43) Pub. Date: Jun. 7, 2007

(54) Professional Services Communications Architecture

(75) Inventors: Michael T. McKibben, Columbus, OH (US); Paul L. Petronelli, San Jose, CA (US)

Correspondence Address: ERIC D. JORGENSON, 1457 KING ROAD, HINCKLEY, OH, 44233, US

(73) Assignee: Leader Technologies, Inc., Westerville, OH (US)

(21) Appl. No.: 11/672,906

(22) Filed: Feb. 8, 2007

Related U.S. Application Data
(63) Continuation-in-part of application No. 10/979,611, filed on Nov. 2, 2004.
(63) Continuation-in-part of application No. 10/731,906, filed on Dec. 10, 2003, now abandoned.
Application No. 10/979,611 is a continuation-in-part of application No. 10/732,744, filed on Dec. 10, 2003, now Pat. No. 7,139,761.
(60) Provisional application No. 60/771,576, filed on Feb. 8, 2006.
(60) Provisional application No. 60/516,307, filed on Nov. 3, 2003.
(60) Provisional application No. 60/432,257, filed on Dec. 11, 2002.
(60) Provisional application No. 60/432,255, filed on Dec. 11, 2002.

(51) Int. Cl. H04L 12/16; H04Q 11/00

(52) U.S. Cl. 370/260; 370/270

(57) ABSTRACT

Professional services call management architecture. A professional services communications system (e.g., of a law firm) interfaces to a web-based call management system to facilitate call management (e.g., teleconferencing) capabilities in a professional services environment. The system can include a professional services communications component that facilitates voice communications, and a web-based call communications component that interfaces to the professional services communications component to facilitate the professional services call management (e.g., accounting to client). The web-based system can also support communications via VoIP. The web-based call management system facilitates communications for at least one of wired and wireless telephone communications systems and, one-way and two-way communications.

### CROSS-REFERENCE TO RELATED APPLICATIONS

This application claims the benefit of U.S. Provisional Patent application Ser. No. 60/771,576 entitled “PROFESSIONAL SERVICES COMMUNICATIONS ARCHITECTURE” and filed Feb. 8, 2006. This application is also a Continuation-in-Part of pending U.S. patent application Ser. No. 10/979,611 entitled “COMMUNICATION SYSTEM AND METHOD” and filed Nov. 2, 2004. The entireties of the above-noted applications are incorporated by reference herein.

### TECHNICAL FIELD

This invention is related to telephone and teleconferencing systems, and more specifically, to providing and interfacing such communications capabilities for professional services.

### BACKGROUND

The advent of global communications networks such as the Internet has facilitated numerous collaborative enterprises. In addition to basic e-mail exchanges and intercommunications, such communications networks offer the capability to provide conferencing arrangements whereby one or many customers can be bridged together on a media conference connection. Individuals and business people seek to communicate with each other, obtain useful information, interact commercially and entertain themselves in an increasingly mobile society. In order to fulfill these needs, one requires the capability to send and receive messages, access information and entertainment content, conduct business transactions, organize daily schedules and generally, stay in touch with homes and offices from almost anywhere, at any time, as easily as making a telephone call.

One method of collaborative communications is via a conference call. A conference call session can utilize a bridge device or system that allows several connection endpoints to be bound together to establish a communications conference session. Communications conferences may include voice, video, data and an assortment of other media streams. Historically, each session participant receives a dial-in number and conference bridge PIN and at the appropriate time dials that number and enters the PIN to establish a communication path between a conference call bridge and the participant's customer station. This type of an arrangement is under the control and supervision of an operator or attendant who can answer, add, or disconnect individual conferees to the bridge with minimal interference to the other conferees connected.

An improvement over the above is a conference call service, which is offered by a third party to set up a conference call between multiple parties. Such services can require an originator to contact a conference call coordinator with the date and time of the call and the telephone numbers (and names) of the participants. The coordinator initiates the conference at the appropriate time by contacting and connecting the participants or having the participants dial in. This frees the originator from manually dialing the telephone numbers of the participants, but requires yet another human operator to coordinate the call.

High-end prior art teleconferencing systems can provide a number of conferencing capabilities. However, such systems can be an enormous cost to businesses (e.g., law firms, accounting firms, . . . ) that can benefit from such options and capabilities. Thus, small businesses are left dealing with legacy systems that have limited teleconferencing capabilities. Moreover, such low-end conventional systems do not provide adequate security as the more costly systems. Despite the proliferation of communication devices and the development of the Internet, significant barriers remain to fulfilling user needs for access to and management of personal, professional and public information. Accordingly, there exists a need for an improved call management capability system for professional services organizations that can provide the advanced features of high cost systems, but for significantly less cost.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, includes a call management architecture for a network-based call processing. In one particular application, the architecture facilitates call and data management from the perspective of a professional services environment, and includes a professional services communications component configured to communicate and exchange data with a web-based call communications component. The term web-based is intended to include IP-capability for any network, as well as capable of being disposed on the Internet or other IP-capable network, and which can include receiving and processing at least web services.

The architecture finds application in professional services environment such as law firms, advertising firms, and accounting firms, for example. The professional services communications component can comprise a local telephone switching system such as a PABX (private automatic branch exchange) system, and/or a VoIP (voice over IP) system that facilitates access to an IP network (e.g., the Internet) for IP packet-based calls thereover, and/or any suitable call processing system for processing calls and/or related data over cellular and terrestrial communications over the network. The professional services communications component interfaces to a web-supported telephone communications component that utilizes IP network services for connecting and routing calls, for example. The architecture supports at least multimedia communications, telephone calls and, call and/or video teleconferencing capabilities.

In another aspect of the subject innovation, a system is provided that facilitates professional call and/or data management services by a user entering or selecting characters from a telephone pad (e.g., *1). Thereafter, a client code can be entered by any number of different means, for example, by entering numbers and/or letters of the telephone keypad, and/to voicing the data into the telephone system for processing.

In another aspect thereof, the disclosed architecture facilitates use of a client PIN (or client account code) for initiating and accounting for calls and/or data.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of professional services communications system in accordance with an innovative aspect.

FIG. 2 illustrates a methodology of a professional services call management in accordance with the invention.

FIG. 3 illustrates a methodology of providing teleconferencing services for a professional services environment in accordance with an aspect.

FIG. 4 illustrates a block diagram of a professional services call management system in accordance with the subject invention.

FIG. 5 illustrates a flow block diagram of a professional services call management system in accordance with the subject invention.

FIG. 6 illustrates a methodology of processing call management for a VoIP phone system in accordance with an aspect.

FIG. 7 illustrates a professional services/call management system that employs an artificial intelligence component for automating one or more features in accordance with the subject innovation.

FIG. 8 illustrates a block diagram of an exemplary call management communications system in accordance with an innovative aspect.

FIG. 9 illustrates a call session system.

FIG. 10 illustrates a methodology of call conferencing.

FIG. 11 illustrates more detailed system diagram of the telephone call processing system of the subject invention.

FIG. 12 illustrates a methodology of performing call conferencing in accordance with the invention.

FIG. 13 illustrates a methodology of processing greetings in accordance with the invention.

FIG. 14 illustrates a methodology of connecting a conference participant to the appropriate conference call session in accordance with the invention.

FIG. 15 illustrates a methodology of creating a new conference call in accordance with the invention.

FIG. 16 illustrates a methodology of processing a received facsimile in accordance with the invention.

FIG. 17 illustrates a methodology of capturing incoming information in accordance with the invention.

FIG. 18 illustrates a methodology of processing a list of names in accordance with the invention.

FIG. 19 illustrates a methodology of managing a conference call session in accordance with the invention.

FIG. 20 illustrates a methodology of managing a session by a host in accordance with the invention.

FIG. 21 illustrates a methodology of managing a conference call session in a no-host manner in accordance with the invention.

FIG. 22 illustrates a general system configuration of the present invention.

FIG. 23 illustrates a sample PIN card that can be used to access a conference call.

FIG. 24 illustrates a block diagram of a computer operable to support the call management and/or professional services business systems of the disclosed architecture.

FIG. 25 illustrates a schematic block diagram of an exemplary computing environment that supports the call management and professional services business system back-office systems in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

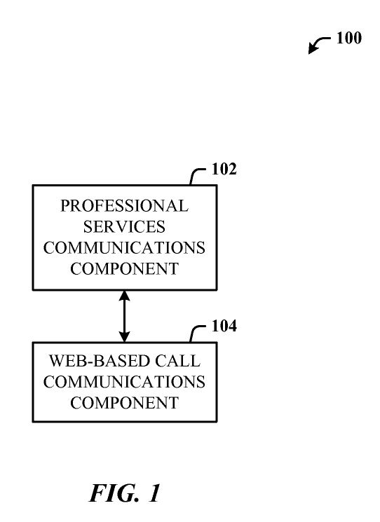

Referring now to FIG. 1, there is illustrated a block diagram of professional services communications system 100 in accordance with an innovative aspect. The system 100 finds application in any professional services environment such as law firms, accounting firms or any other professional services businesses. The system 100 can include a professional services communications component 102 which can comprise a local telephone switching system such as a PABX (private automatic branch exchange) system, and/or a VoIP (voice over IP) that facilitates access to an IP network (e.g., the Internet) for IP packet-based calls thereover.

The professional services communications component 102 interfaces to a web-supported (or web-based) telephone call communications component 104 that utilizes IP network services for connecting and routing calls, for example. The terms web-supported are intended to at least mean IP-capable for any packet network, as well as capable of being disposed on the Internet, and capable of receiving and processing web services. In one implementation, the web-supported telephone communications component 104 facilitates teleconferencing of multiple callers and telephones (e.g., wired and/or wireless) into a call session. This is described in greater detail herein. Thus, when employed in combination with the telephone communications component 104, the professional services environment can provide additional flexibility for employee and client communications and accounting services in a more robust manner than conventional systems.

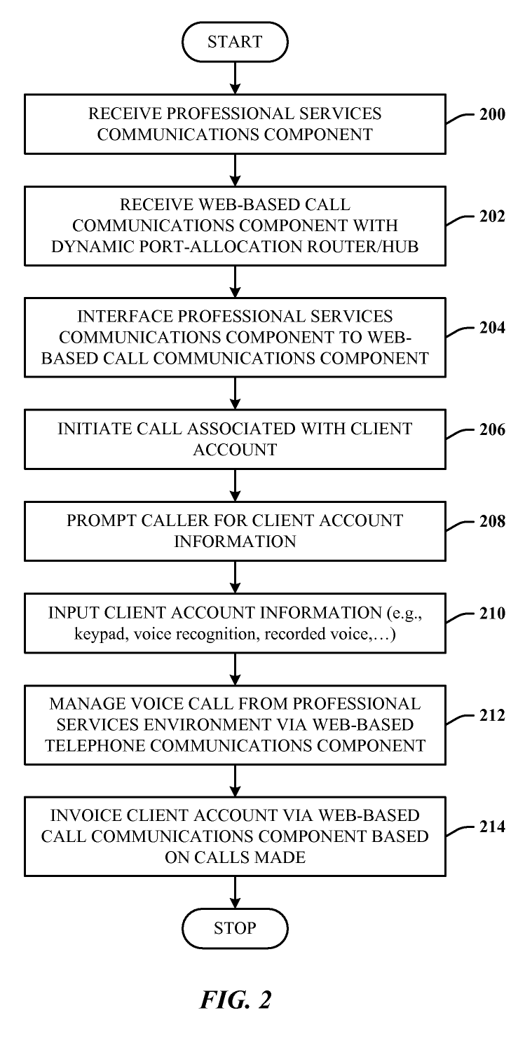

FIG. 2 illustrates a methodology of a professional services call management in accordance with the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 200, a professional services communications component (e.g., a PABX) of a professional services environment is received. At 202, a web-based telephone communications component is received that includes a dynamic port allocation router/hub. At 204, the web-based telephone communications component is interfaced to the professional services communications component to facilitate professional services environment telephone communications via the web-supported telephone communications component. At 206, a call can be initiated that is associated with a client account. The call can be initiated via a professional services telephone system by inputting a special code (e.g., a “*” and a “1” or by pressing a designated speed dial key) that automatically routes call management to the web-based telephone communications component. In response, the call management system can be configured to prompt the user via a record voice message for a client code that can be associated with a client of the professional services business, as indicated at 208.

At 210, the caller listens to the automatic prompt and then inputs a client account code or information. This input process can be by the caller keying in the code via the telephone keypad, voicing the code information into the phone which can then be stored as an audio file and retrieved later for account processing, and/or the voiced information can be recognition processed to determine the spoken client code. At 212, the telephone communications component manages the call by facilitating connection of the call to the callee. Additionally, such management function can include timing the duration of the call in order to properly charge for the carrier charges, as well as facilitate attorney time, any other time-related charges for the services provided.

It is to be understood that should the caller choose not to process the call according to a client account even after initiating the client account call management process to the web-based communications component, the caller can enter and/or voice a response that exits the system in order to continue with the call, yet not invoke the call management system.

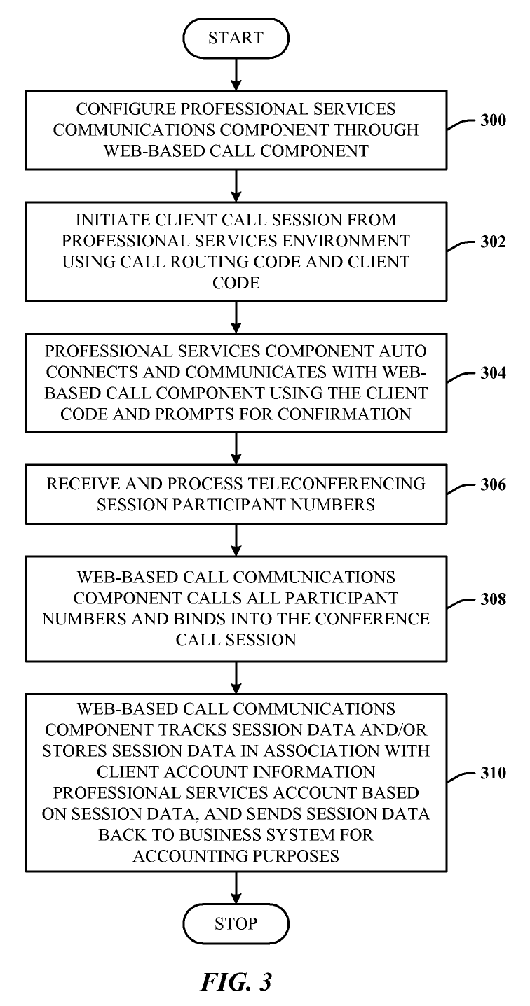

FIG. 3 illustrates a methodology of providing teleconferencing services for a professional services environment in accordance with an aspect. At 300, a professional services communications component (e.g., a PABX) of the professional services environment is configured for intercommunication with the web-based call communications component. At 302, a professional services employee (or caller) initiates a client call teleconferencing session from the professional services environment by entering a call routing code (e.g., *1 or a designative speed dial key) that is processed by the professional services communications component to auto-connect the professional services communications component to the web-based call communications component, as indicated at 304. Note that the architecture is sufficiently robust to allow the caller to enter both the call routing code and the client code sequentially without the system prompting the caller to do so. For example, the caller can pick up the phone and enter *12345600 in succession. The system can then automatically parse the numbers (or characters) such that the characters “2345600” after the initial “*1” or speed dial characters will be interpreted as the client number, and processed accordingly. Under such circumstances, the system can then confirm to the caller that the caller entered the desired client account code by playing back the code to the caller for confirmation.

As an alternative background function, the call communications component can be configured to access the professional services business system via a secure connection such that when a client account number is entered by the caller, the business system can be accessed and the corresponding client name retrieved and played back to the caller as a form of confirmation. For example, when client account number 12345 is entered, the telephone system can now play back a message to the caller similar to “You chose to log this call to client XY Corporation, is this correct?” after which the caller can confirm or deny with the proper manual selection on the phone and/or voice response.

The business system initiates telephone communications to the web-based call communications component via a dynamic port allocation router/hub for call routing and binding. At 306, the call management communications component receives and processes recipient telephone numbers for the conference call session. This can be accomplished by the system further prompting the caller for the session participant telephone numbers, as well as alternative numbers, for example. Alternatively, as indicated above, the caller can access a website that receives as input the participant call numbers for the session, which are then executed automatically when the caller initiates the teleconferencing session.

At 308, the call communications component calls all participant telephone numbers and binds the terminated calls into the conference call session. At 310, the call communications component tracks session data, and transmits corresponding data back to the business services system for client accounting purposes.

The web-supported telephone communications component can process and bind not only telephone calls into the conference session, but also other computing devices to for one-to-many and many-to-many call interaction using two or more wired and/or wireless voice-capable and/or text messaging devices (e.g., cellular telephones, PDAs, IM messaging devices, etc.). Additionally, a call conference participant can also participate in the call session using messaging technology such as SMS (short message service), MMS (multimedia message service), and the like. Moreover, the call communications component also facilitates video conferencing with voice and other multimedia content, as desired.

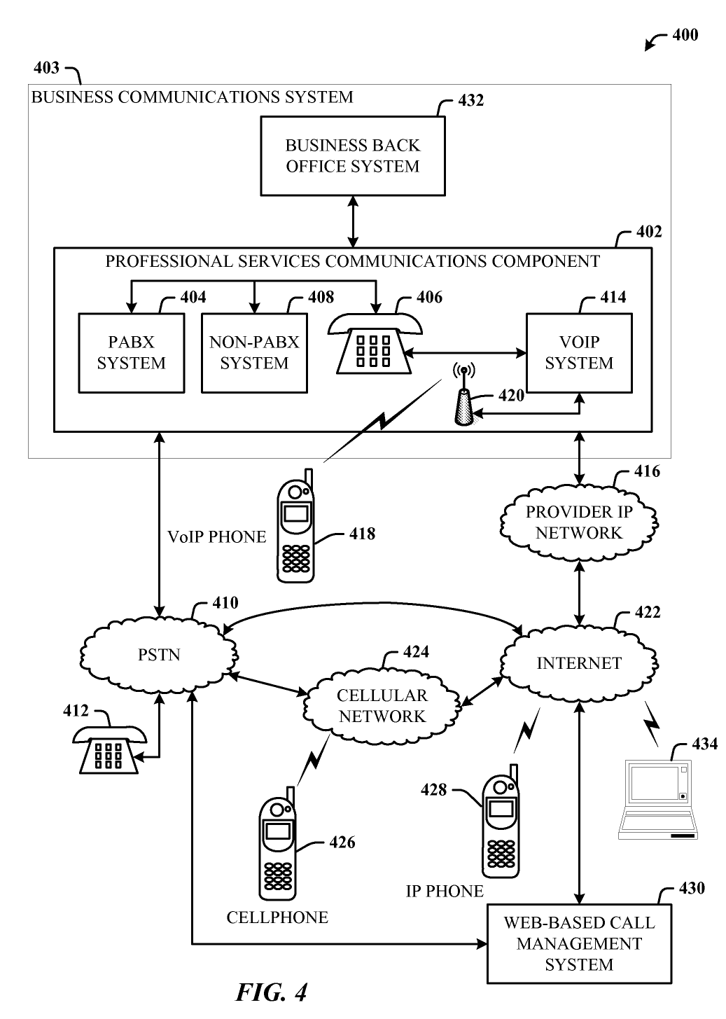

FIG. 4 illustrates a block diagram of a professional services call management system 400 in accordance with the subject invention. The system 400 can include a professional services communications component 402 (similar to component 102 of FIG. 1) of a professional services business system 403 that facilitates call circuit-switched and/or IP-packet communications for the professional services location. As indicated supra, the component 402 can include a PABX subsystem 404 that automatically processes and routes outgoing calls from telephones 406 or to the telephones 406 from incoming calls, and/or a non-PABX telephone system 408 such that each of the telephones 406 has a line or can share a line to the outside (e.g., PSTN). The professional services component 402 interfaces to the PSTN (public switched telephone network) system 410 for conventional circuit-switch communications to a handset 412 connected thereto.

The professional services component 402 can also include a VoIP system 414 that facilitates VoIP voice communications of an IP network 416 from the telephone 406, which can be a VoIP telephone that is wired to the VoIP system 414. The VoIP system 414 can also be accessed by a wireless VoIP telephone 418 that can be used by an employee, for example. The VoIP phone 418 can communicate with the VoIP system 414 via a wireless access point 420 or other suitable IP-based systems (e.g., a SIP (session initiation protocol) server as part of the VoIP system 414) that interfaces to the VoIP system 414. Thus, an employee can use the wireless VoIP phone 418 or the VoIP phone 406 to make calls over the IP network 416 to the Internet network 422 to terminate at other telephone handsets (e.g., handset 412).

The Internet 422 interfaces to a cellular network 424, which can further interface to the PSTN system 410 such that VoIP calls initiated at the professional services environment can be terminated at the conventional handset 412. Conversely, incoming calls from the PSTN 410 (e.g., via the phone 412), the cellular network 424 (e.g., via a cell phone 426), and/or the Internet 422 (e.g., via an IP phone 428) can be terminated at the business communications system 403 via handsets 406 that interface to the PABX system 404, the non-PABX system 408, and/or the VoIP system 414. Call charges can be received and processed via a business back office system 432.

The system 400 can also include a web-based call management system 430 (similar to the web-based call communications system 104 of FIG. 1) that includes hardware and/or software for managing calls from the business system via the professional services communications component 402. For example, as indicated herein, the business system 403 can offer teleconferencing capabilities that are managed by the web-supported call management system 430. An employee can enter a special input code (e.g., *1, speed dial key, . . . ) via the phone 406. In one implementation, in response to receiving the code, the services component 402 automatically dials a toll-free number (e.g., an 800 number) that connects to the call management system 430. Thereafter, at least a PIN (a unique PIN assigned only to the business system 403) and the employee number are transmitted via the PABX system 404 or the non-PABX system 408 over the PSTN 410 directly and/or indirectly to the call management system 430. This can be directly to the management system 430 via the PSTN 410, indirectly to the call management system 430 by way of the PSTN 410 and the Internet 422, and/or indirectly to the call management system 430 by way of the PSTN 410, the cellular network 424 and the Internet 422.

Once received, the call management system 430 opens a call conferencing session to which other callers can connect and be bound to. For example, a caller that uses the phone 412 can dial into the conference call session via the PSTN 410 by calling a tolled or toll-free number that is picked up by the call management system 430 and entering a PIN number that is uniquely assigned to the session. Similarly, users of the VoIP phone 418, the cell phone 426, and the IP phone 428 can separately dial-in to the call management system 430 via the VoIP system 414, the cellular network 424 and the Internet 422, respectively, in order to enter the conference call session.

Alternatively, the telephone numbers of the session recipients are known, and have been submitted to the call management system 430. The call management system 430 initiates the conference session at a predetermined time by calling each of the submitted phone numbers, which can include connecting to the handset 412, the cell phone 426, the VoIP phone 418, the handset 406, and/or the IP phone 428 at the appointed time. When the calls are received into the call management system 430, each is bound into the conference session. Other callers who happen to call into the management system 430, but who are not registered with the session will not be allowed to enter the session. It is to be appreciated that computing devices that include voice capability can also connect into the conference session via a wired and/or wireless circuited-switched or packet-switched network. For example, a user with a portable computer 434 can be called and bound into a conference call session.

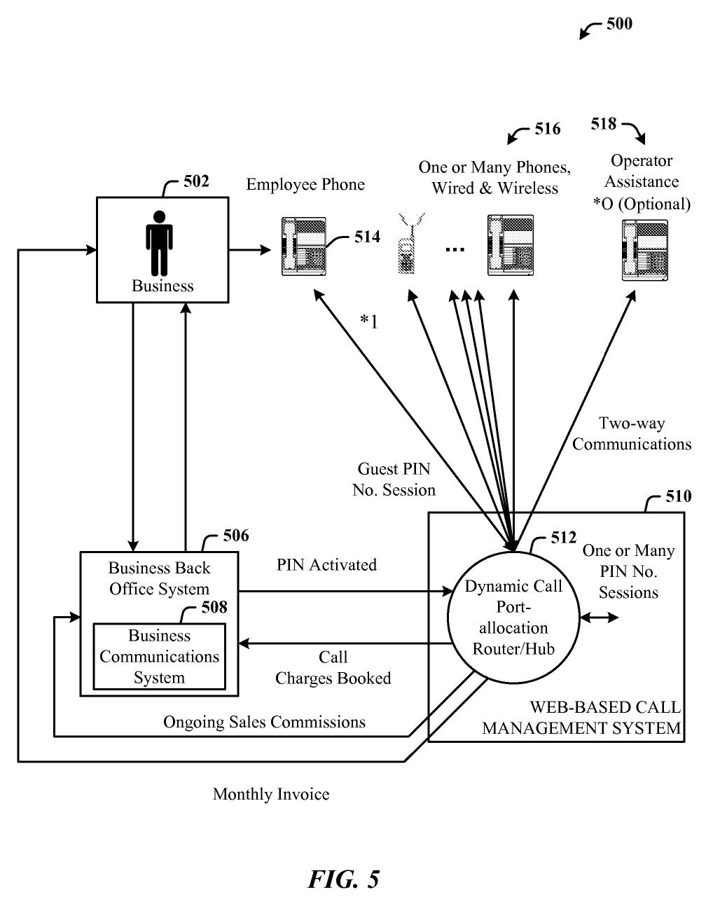

FIG. 5 illustrates a flow block diagram of a professional services call management system 500 in accordance with the subject invention. When a business 502 subscribes to the web-based call management architecture, the business 502 can receive a unique PIN. It is to be understood that other services can also be provided (video content, messaging services, . . . ). The professional services back-office system 506 can also include a business communications system 508 which facilitates the communications for the business and all employee calls and phones. This can include wired and/or wireless voice, data, and VoIP systems, for example, such as are mentioned herein.

The back-office system 506 facilitates communication of the PIN to a web-supported call management system 510 (similar to web-based systems 104 of FIG. 1 and system 430 of FIG. 4). This process can also include transmission of the business information and financial/account information (e.g., credit card, bank account, . . . ). However, such information is not required to be communicated to the call management system 510. Simply the fact that the PIN has been communicated to the call management system 510 can suffice to activate the business PIN. Once the PIN has been transmitted to the management system 510, it can be activated for use. Thereafter, when the business calls the toll-free number and enters the PIN, call services (e.g., teleconferencing) can be made available to the business via the call management system 510. It is to be understood that the PIN card is not the only means of placing voice calls.

The call management system 510 can also include a dynamic port-allocation router/hub system 512 that can bind multiple calls into a call session. For example, where the business employee chooses to initiate or participate in a conference call session via a telephone 514, the hub system 512 includes hardware and/or software to make this happen. When the employee utilizes the call management system 512 and any services provided thereof, this use can be tracked and charged back to the business and/or the client account of the business. Thus, if initiating and/or participating in a conference call from the phone 514 by selecting a predetermined code (e.g., *1 or speed dial), this information can be tracked and billed appropriately. The hub system 512 facilitates calling or connecting to (e.g., for messaging) one or more wired and/or wireless phones 516. At anytime during the call session, a conference call, or the like, the participant can also select another predetermined code (e.g., *O) for operator assistance 518 on the same voice channel as the call. Thus, two-way communications then exists between the operator assistant 518 and the telephone 514. This can be made optional.

Once the call is over, the call management system 510 transmits the call session information back to the business back-office system 506 for charging against the appropriate account (e.g., client, business, . . . ).

The call management system 510 by way of the dynamic port allocation hub system 512 can accommodate many simultaneous call sessions, whether single calls or conference calls. Additionally, it is to be understood that although depicted as a single system, the call management system 510 can include multiple hub systems 512 interconnected for call management.

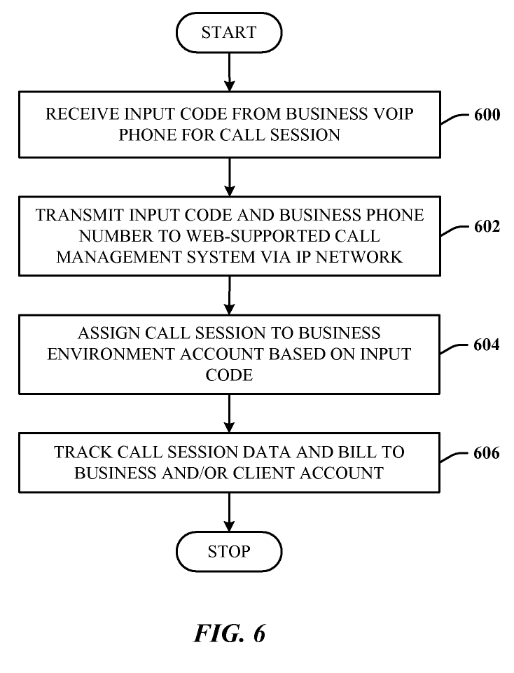

FIG. 6 illustrates a methodology of processing call management for a VoIP phone system in accordance with an aspect. At 600, a special code is input via the VoIP phone of the business. At 602, the VoIP system receives the special code input and routes the code information along with business phone number and business PIN to the call management system over an IP network. The routing information can include an IP address associated with the call management system. At 604, the call session is configured and assigned to the business account. At 606, the call session can be tracked and billed back to the business and/or client account.

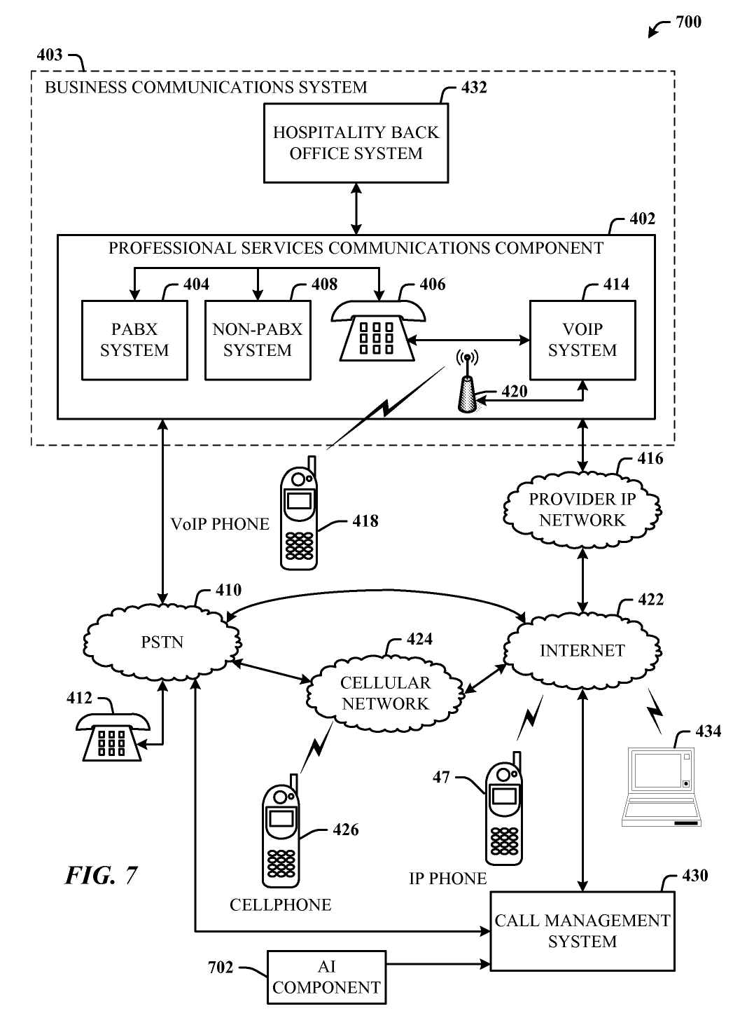

FIG. 7 illustrates a professional services/call management system 700 that employs an artificial intelligence (AI) component 702 which can utilize AI techniques for automating one or more features in accordance with the subject innovation. For example, a process for determining what commission-based schemes to employ for the provider can be facilitated via an automatic classifier system. The classifier can be explicitly trained as well as implicitly trained (e.g., via observing user behavior, receiving extrinsic information, . . . ). Thus, the classifier(s) can be employed to automatically learn and perform a number of functions, including but not limited to determining according to predetermined criteria how much time to allot to a caller based on caller call activity. For example, if the business employee has input the call routing code for a conference call session, and from monitoring past activity by the call management system, determines that the employee routinely utilizes such a feature, the business account can be automatically upgraded to a subscription level that provides the same services at a cheaper rate (rather than charging the guest additional fees for using over the allotted time).

In another example, based on the amount of business activity, the AI component 702 of the call management system 700 can learn and reason to automatically upgrade the provider to a higher level of subscription (or quality of service) based on the increased activity. When the business activity is reduced, the AI component 702 can then automatically downgrade the level of services.

These are only but a few examples of the automation that can be provided via the AI component 702, and are not to be construed as limiting in any way. For example, based on business and/or employee profile information and past business and/or employee interaction, it can be reasoned and learned that the business invoice can be automatically charged to a certain financial account.

Additionally, the AI component 702 can be employed to determine at what times to synchronize the call management system with the provider back-office system for the exchange of session information and other suitable information desired to account for session activity and provider commissions, for example.

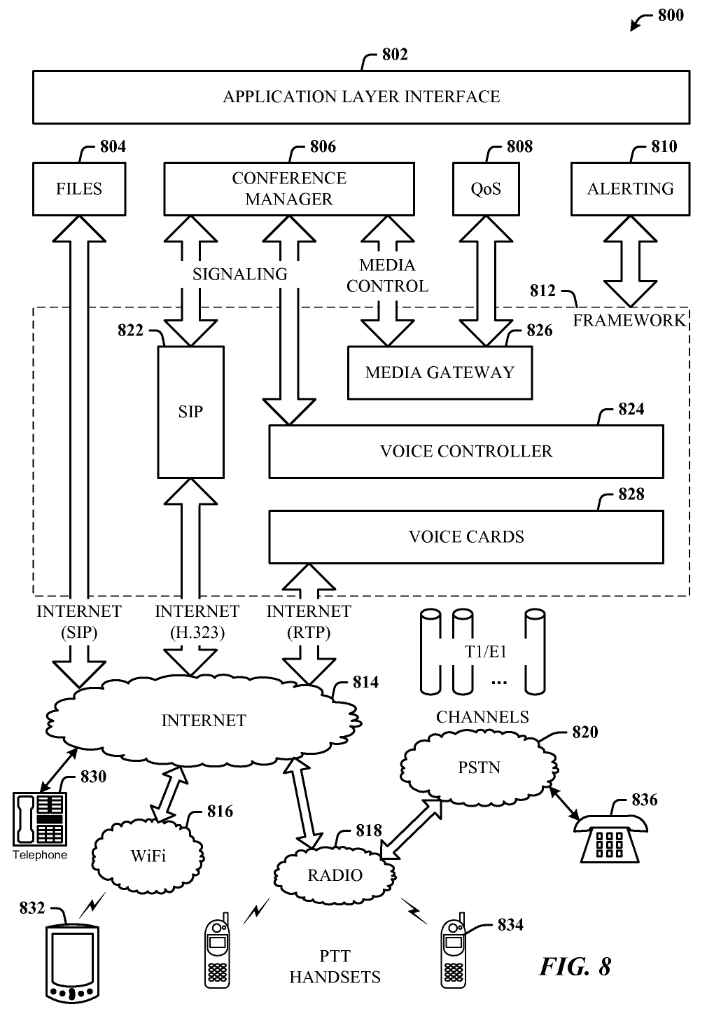

FIG. 8 illustrates a block diagram of an exemplary call management communications system 800 in accordance with an innovative aspect. The call management system 800 can be employed as a telephony conferencing manager for call conferencing, as desired. The system 800 can include an application layer interface 802 that provides exposure to overlying applications and underlying files 804, a conference manager 806, a quality-of-service (QoS) component 808, and an alerting component 810.

The system 800 can include a communications framework 812 via which the files 804, conference manager 806, (QoS) component 808, and an alerting component 810 can interface to external networks (e.g., the Internet 814, a Wi-Fi network 816, a radio network 818, and/or a PSTN network 820). The files 804 can be communicated directly through the framework 812 to the internet using SIP (session initiation protocol). The conference manager 806 can interface to the Internet 814 and other networks via a SIP component 822 of the framework 812, and therefrom via an H.323 protocol to the Internet 814, to exchange signaling information.

H.323 is an international standard for multimedia communications over packet-switched networks, including LANs, WANs, and the Internet. H.323 is an “umbrella” specification that includes the standards H.323, H.225.0, H.245, the H.450-series documents, and the H.460-series. H.323 allows for the use of T.120 protocols for data collaboration and file transfer. T.120 is data conferencing standard that provides real-time communication between two or more entities in a conference. Applications specified as part of the T.120 family can include application sharing, electronic white boarding, file exchange, and chat. T.120 may be used stand-alone or in conjunction with other protocols, such as H.323 and SIP.

SIP is an IETF (Internet Engineering Task Force) standard for the establishment of multimedia sessions, which can be used for audio, video, messaging (e.g., instant messaging) and/or other real-time data communication sessions. The scope of SIP is relatively broad, including the establishment of virtually any kind of session between two parties.

The scope of H.323 can cover real-time voice (e.g., VoIP), video, and data communications over packet-switched networks. H.323 is designed to operate over IP networks, primarily, though H.323 can also operate over other packet-switched networks. H.323 includes multipoint voice and video conferencing capabilities.

The conference manager 806 can also interface to internal components of the framework 812. For example, signaling information can also be communicated to a voice controller component 824 (e.g., an NMS natural access card by NMS Communications of Framingham, Mass.). Natural Access is a modular runtime and development environment for creating voice, fax, and call processing applications using NMS media processing platforms and can provide a consistent application programming interface (API) for integrating and presenting media and telecommunication capabilities to an application. Standard features include telephony call control, voice record and playback, tone detection and generation, and industry-standard H.100/H.110 switching support.

The conference manager 806 can also interface to an internal media gateway component 826 (e.g., fusion-an IP telephony API programming environment by NMS Communications) of the framework 812. The conference manager 806 can communicate at least media control information to the media gateway 826. The QoS component 808 can also interface to the media gateway 826 to communicate QoS information. The alerting component 810 can interface to the framework 812 for the communication of alerts and notifications, for example.

The communications framework 812 can also include one or more voice cards 828 (e.g., a model CG6565 card by NMS Communications, or other similar vendor models having similar capabilities) that facilitate the conversion of voice signals into voice data for transmission to the Internet 814 via RTP (real-time transport protocol) technology. RTP can be employed to support streaming real-time multimedia over IP in packets (e.g., voice and video over packet-switched networks).

The framework 812 can also provide other types of packet communications channels such as T1 (1.54 Mbps) and/or E1 (2.048 Mbps) to the PSTN 820. Thus, the system 800 can facilitate communications to an IP phone 830 for VoIP, a PDA 832 in communications with the Wi-Fi network 816, push-to-talk devices 834 that communicate via the radio network 818 (e.g. mesh radio networks for emergency services), and conventional telephones 836 that connect to the PSTN system 820, for example.

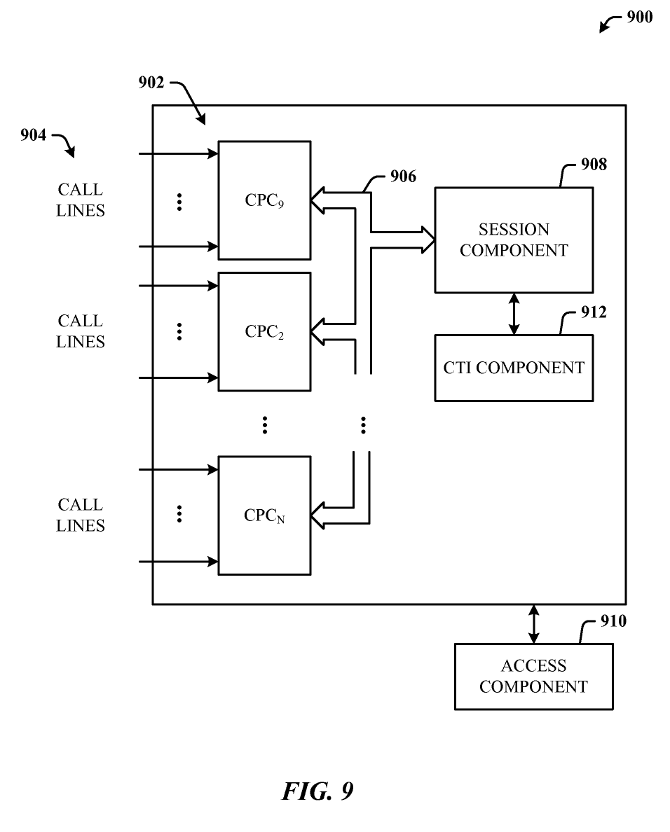

Referring now to FIG. 9, there is illustrated a call session system 900 in accordance with the subject invention. The system 900 includes one or more call processing components 902 (denoted CPC₁, CPC₂, . . . , CPC_{N}) that provide the capability to receive and transmit calls via call lines 904 (e.g., as provided by digital T1 and E1 communications architectures), and process signals and data for at least the management of call conferencing. The one or more call processing components 902 intercommunicate control signals and data across a non-voice communications bus 906. In accordance with a novel aspect of the subject invention, a session component 908 resides on the bus 906 in communication with the one or more call processing components 902 to facilitate routing of one or more of the calls across the non-voice communications bus 906, which is a departure from the designed purpose of the bus 906.

The session component 908 bridges the one or more call processing components 902 across the bus 906 in such a way that is significantly more efficient and allows for dynamic assignment of ports across the multiple cards at the time of receiving or initiating a call. Conventionally, software is written to allocate an assigned port for a received call, and use that port until the call is finished. In the system of the invention, the system does not even consider which port to allocate until the call starts, allocates the first available port, and dynamically allocates more or less ports as the demand increases and decreases. During the session, the system knows which ports are being used, and at the end of the session, releases the ports back into the pool of ports to be re-utilized.

In support of call management, the session component 908 can manage a single call across processing resources (e.g., DSP—digital signal processor resources) of at least two of the CPCs (e.g., CPC₁ and CPC₂). Additional features of echo cancellation, noise reduction, volume control, etc., are facilitated by dedicating some of the DSP resources of the CPCs for these purposes. It is within contemplation of the subject invention that other functions can be dedicated to additional DSP resources where suitable code is provided.

The system 900 also includes an access component 910 that facilitates user interaction with features provided in code by the session component 908. The system 900 exposes itself as a network-based API (application program interface) that facilitates processing of general functions, for example, “dial this number”, “play this .wav file on this line”, “bind this line into this conference call”, and “create a new conference call.” In contrast, the session component 908 manages the ports and DSP resources as one large entity of ports and resources.

The session component 908 interfaces to a CTI (computer telephony interface) component 912 that exposes itself as a remote Java™ API to which the access component 910 interfaces. Thus, the graphical user interface provided by a browser interfaces to the CTI component 912, and not to the session component 908 and underlying hardware and software. Note that although the CTI component 912 is shown internal to the system 900, it can be implemented as a separate entity external to the system 900, as hosted on a personal computer, for example.

The bus 906 is a secondary bus that typically handles signals and data, and which are non-voice communications. One example of the communications architecture employed by the bus 906 is an MVIP (multi-vendor integration protocol) architecture. Another more recent enhancement to the MVIP architecture provides the basis for H.100 bus and H.110 bus architectures, such as found on a model AG4000C board, and other suitable boards manufactured by NMS Communications, of Framingham, Mass.

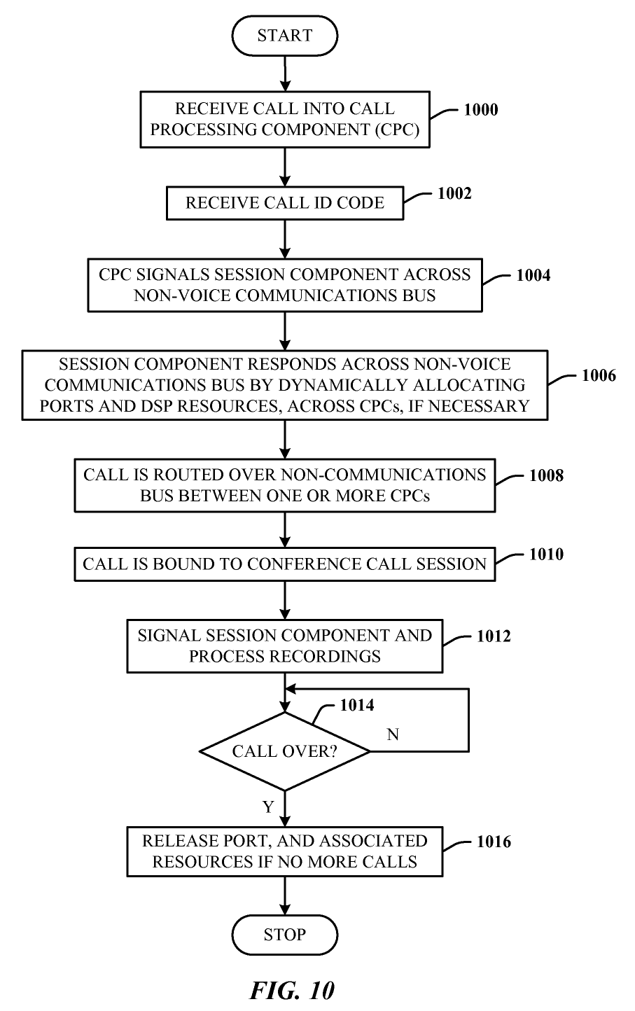

Referring now to FIG. 10, there is illustrated a methodology of call conferencing in accordance with the invention. At 1000, a call is received at a CPC. The user, in accordance with the invention, also provides an ID, as indicated at 1002. This can be a participant ID that indicates the caller is a participant in a conference call session, or a host ID that indicates the caller will be the host of the conference call. At 1004, the CPC that received the call signals the session component across the non-voice communications bus. At 1006, the session component responds across the non-voice communications bus by dynamically allocating ports and DSP resources, across CPCs, if necessary. If necessary, at 1008, the call is routed over the non-voice communications bus to be processed by the assigned resources on a different CPC than the one that received the call. At 1010, the call is bound to a conference call session. At 1012, the session component is signaled with respect to one or more recordings that can be played in association with the call. At 1014, the system checks if the call is over. If no, flow loops back to keep checking. If yes, at 1016, the session component disconnects the call and releases the associated port. If the call is the last of the session, the associated DSP resources will also be released for reassignment to another call session.

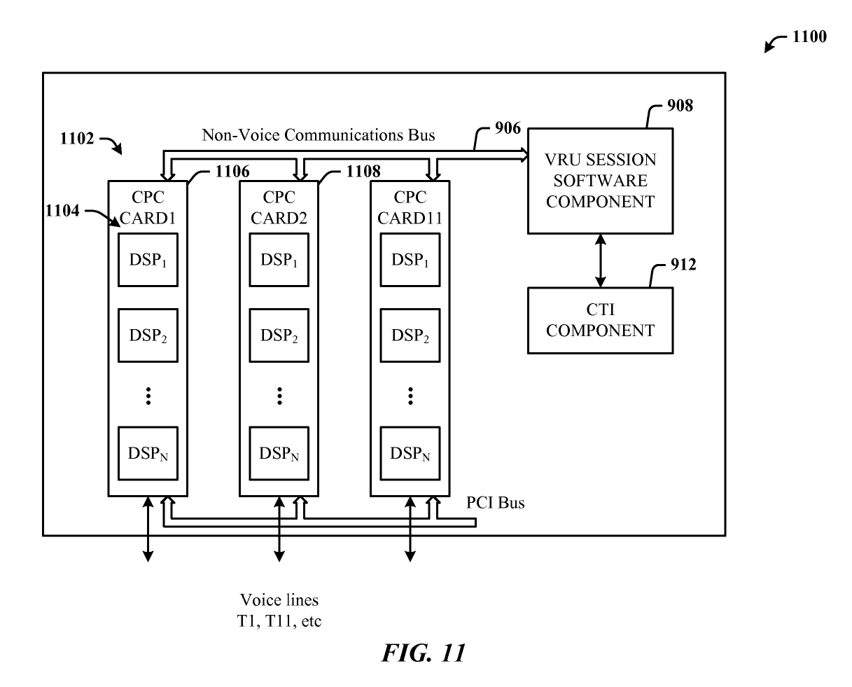

Referring now to FIG. 11, there is illustrated more detailed system diagram of the telephone call processing system 1100 of the subject invention. The system 1100 (similar to system 900 of FIG. 9) receives incoming calls over voice lines, such as T1 and E1 digital communications connections. One or more separate lines can be provided for each CPC card 1102 (denoted here as CPC Card1, CPC Card2, and CPC Card3). Each of the CPC cards 1102 includes DSP resources 304 (represented as DSP blocks DSP₁, DSP₂, . . . , DSP_{N}) to which an incoming call is assigned for processing. In accordance with the subject invention, each of the DSP resources 1104 is allocated to perform same or different tasks. For example, a first DSP resource (DSP₁) can be allocated for echo cancellation, a second DSP resource (DSP₂) can be allocated for volume control, and a third DSP (not shown) can be allocated for noise reduction, all of which are associated with one or more calls.

The allocation of such DSP resources 1104 is accomplished by the session software component 908 (designated as the VRU—voice response unit) that communicates associated commands across the non-voice communications bus to the respective CPC cards 1102. Moreover, a call received at a first CPC card 1106 can be routed across to a second CPC card 1108, via the non-voice communications bus. Thus, the burden of call processing can be scaled to another card. Ultimately, all CPC processing cards and incoming voice lines appear to be one large bound conference-calling platform.

The CTI component 912 facilitates interfacing to the system 1100 such that high level commands can be processed and communicated to the session component 908 for execution across the non-voice communications bus 906 to the CPC cards 1102.

At a higher level, the many call conferencing benefits and functions can be performed in accordance with the system 1100 of the subject invention. A user can interface to the system 1100 to facilitate a conference call, by initiating contact with prospective participants, binding callers to a specific conference call session, muting, disconnecting, and performing many other functions in accordance with the subject invention.

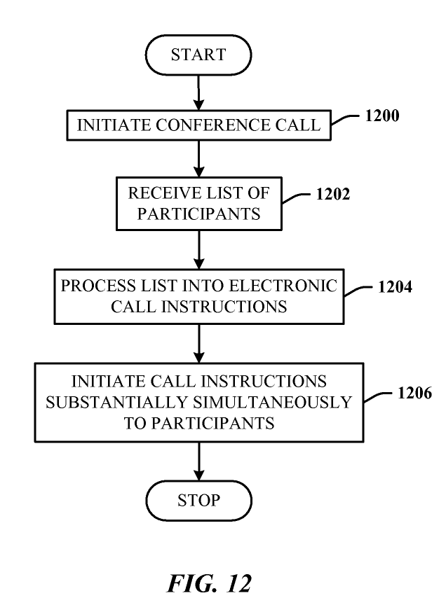

Referring now to FIG. 12, there is illustrated a methodology of performing call conferencing in accordance with the invention. The system is capable of simultaneously dialing several participants at once and binding them to a conference call. Accordingly, at 1200, a conference call session is initiated. At 1202, a list of participants is received. At 1204, the list is processed into electronic call instructions. At 1206, the call instructions are processed to initiate calls substantially simultaneously to all participants on the list.

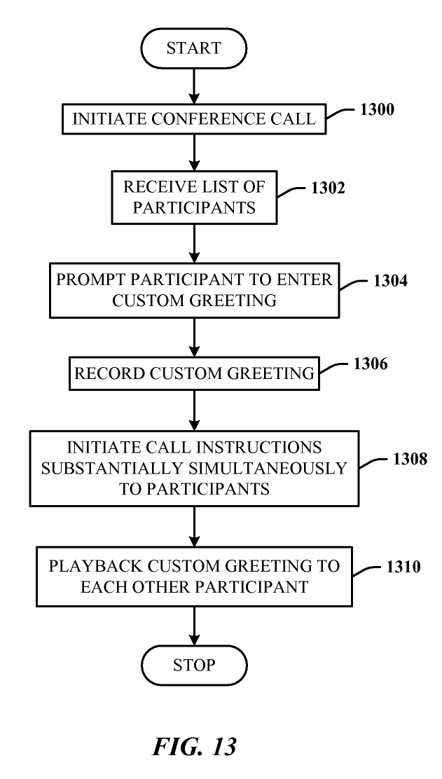

Referring now to FIG. 13, there is illustrated a methodology of processing greetings in accordance with the invention. The software is also capable of calling a conference call host (referred to herein as a “hosted” conference call session), prompting the host for a custom greeting, recording the custom greeting, and replaying the custom greeting to other participants invited to the conference call. Accordingly, at 1300, a conference call session is initiated. At 1302, a list of participants is received and processed. At 1304, a host is called and prompted to enter a custom greeting. At 1306, the custom greeting is input by the host and stored. At 1308, call instructions are initiated substantially simultaneously to all participants. At 1310, the custom greeting is played back to the session participants who are then logged in to the session. Where a host is not designated, this is referred to herein as a “non-hosted” conference call session.

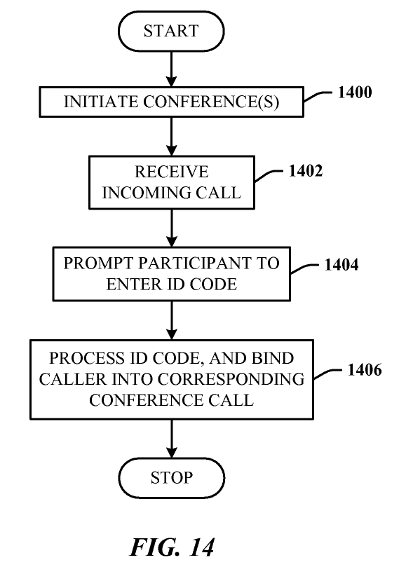

Referring now to FIG. 14, there is illustrated a methodology of connecting a conference participant to the appropriate conference call session in accordance with the invention. At 1400, several conference call sessions have been initiated and/or are in session. At 1402, the system receives an incoming call of a session participant. At 1404, the system prompts the caller to enter an ID code. At 1406, the system processes the ID code, and binds the caller as a participant into the conference call session that corresponds to the ID code.

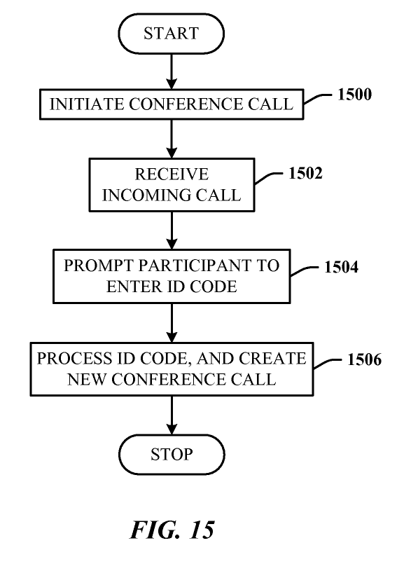

Referring now to FIG. 15, there is illustrated a methodology of creating a new conference call in accordance with the invention. At 1500, a conference call is initiated. At 1502, an incoming call is received. At 1504, the caller is prompted for an ID code. At 1506, the ID code is processed, and a new conference call session created.

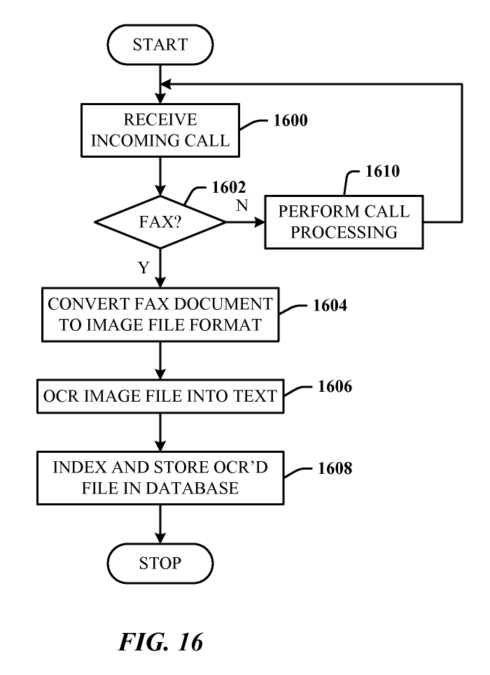

Referring now to FIG. 16, there is illustrated a methodology of processing a received facsimile in accordance with the invention. At 1600, the system receives an incoming call, and analyzes the call signals. At 1602, if the incoming call is a fax transmission, flow is to 1604 to convert the fax document to an image file format (e.g., a TIFF file) and store the converted document to a hard drive or other storage device. At 1606, the image file is processed by optical character recognition (OCR) into plain text data. At 1608, the plain text of the fax can be written to a file for indexing and insertion into a database. At 1602, if the call is not a fax, flow is to 1610 to process the call normally as a voice call.

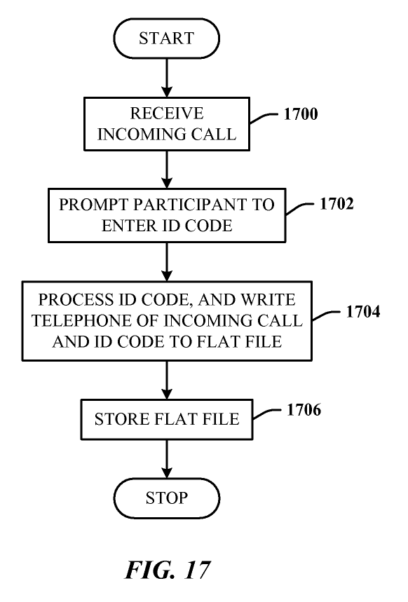

Referring now to FIG. 17, there is illustrated a methodology of capturing incoming information in accordance with the invention. At 1700, an incoming call is received. At 1702, the caller is prompted to enter an ID code. At 1704, the system processes the ID code, and writes the telephone number and ID code of the prospective conference call participant in association therewith to a flat file. At 1706, the flat file is then stored for later processing.

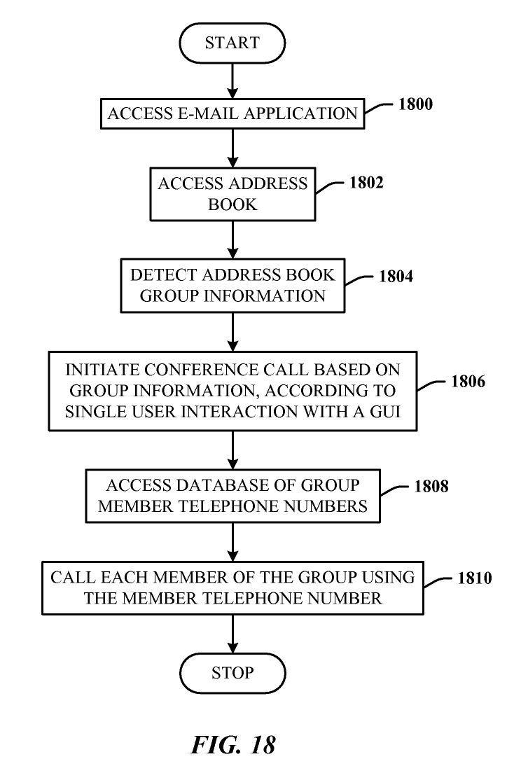

Referring now to FIG. 18, there is illustrated a methodology of processing a list of names for a conference call in accordance with the invention. The list of names can be obtained from any data source. For example, in one implementation, a user may establish “groups” from an address book such as that found in Microsoft Outlook™, for example, and the software is capable of allowing the conference manager to invite each member of the group to participate in the conference call via a graphical user interface (GUI) with a single input action (mouse-click). Accordingly, at 1800, a data source (e.g., an e-mail application) is accessed. At 1802, a list of names (e.g., an address book) is accessed therefrom. At 1804, grouping information (e.g., from within the address book) is detected, if available. At 1806, a conference call session is initiated (e.g., based on the grouping information), and according to a single user click and/or interaction with the GUI. At 1808, a database of telephone numbers is accessed from a database. At 1810, each member of the list (e.g., the group) is called using the corresponding member telephone number. As indicated supra, the list of names and any associated grouping information can be obtained from any program and/or data source such as a contacts file stored in an e-mail program, a contacts file stored in a PDA, a cell phone address book, and so on.

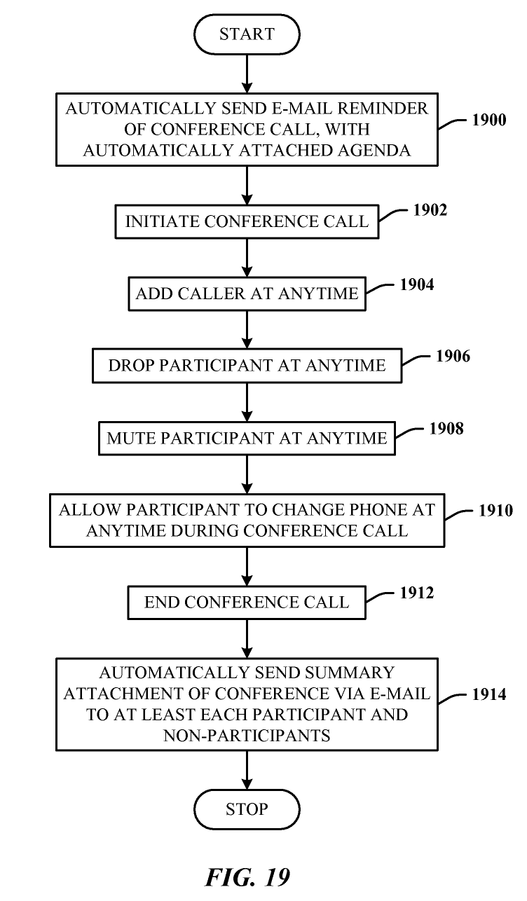

Referring now to FIG. 19, there is illustrated a methodology of managing a conference call session in accordance with the invention. The system of the subject invention permits callers to be added, muted, and/or dropped at any time, and allows callers to change phones in mid-call. The system can call out to participants simultaneously, eliminating the need to wait for everyone to get online, or can let them call in, adding them at any time. The system can send reminders using a variety of mechanisms with the agenda and minutes automatically prior to calls, during calls, and in written summaries of conference call sessions afterwards. In one implementation, the system enables up to fifty-five participants to be bound at one time into a conference call session. However, this is not to be construed as limiting, since additional capacity in terms of hardware and/or software facilitates the addition of a greater number of session participants is within contemplation and scope of the invention.

Accordingly, at 1900, the system can automatically send a reminder to each potential session participant via e-mail or other messaging mechanisms (e.g., SMS-short message service, MMS-multimedia messaging service, . . . ), and with an automatically attached session agenda and file attachments. At 1902, the conference call session is initiated. At 1904, a caller can be added to the session at anytime. At 1906, a session participant can be dropped from the session at anytime. At 1908, a session participant can be muted at anytime. At 1910, a session participant can be allowed to change telephones at anytime during the session. At 1912, the conference call session ends. At 1914, a session summary can be automatically sent to each participant and/or to any non-participant.

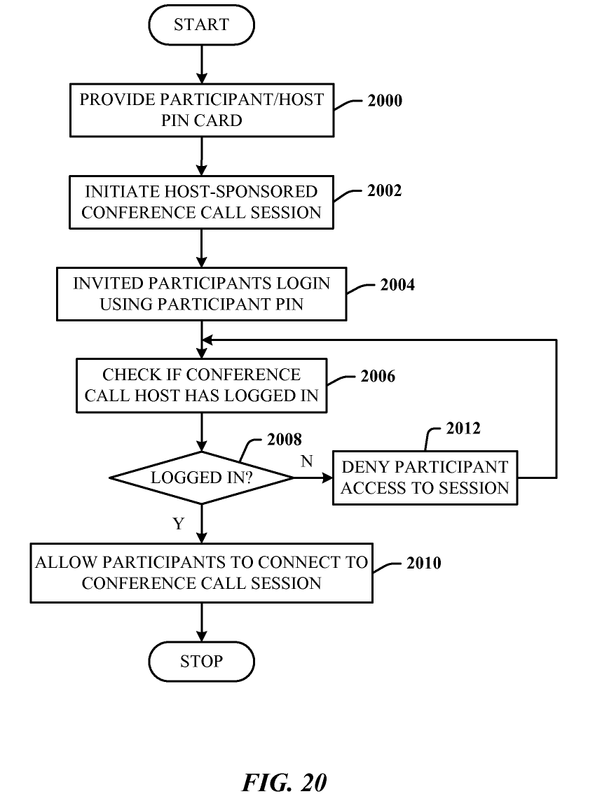

Referring now to FIG. 20, there is illustrated a methodology of managing a session by a host in accordance with the invention. Conference calls may be managed from virtually any computing device and/or telephone, e.g., a touch-tone phone, mobile telephone, personal computer or a wireless PDA (e.g., a Palm™ PDA). More particularly, in keeping with a particularly preferred aspect of the invention, users or participants can dial-in using a Participant Identification Number (PIN), while the host dials in with another PIN (called a host PIN) that can be used to control when the conference starts, for example. In this way, only when the host dials-in will the other callers be connected. This is a particularly effective method for a manager or other supervisor to maintain better control over their conference call session. Additionally, it allows customers the opportunity to issue credit card size conference calling cards containing a permanent host PIN and participant PIN to each person who wishes to make conference calls, without ever even having to use a browser interface.

At 2000, a participant/host card is provided with corresponding PINs for each function. At 2002, the caller initiates a host-sponsored (or hosted) conference call session. At 2004, invited participants log in using the participant PIN. At 2006, the system determines if the host has logged in to start the session. If so, at 2008, flow is to 2010 to allow callers to check in to the session as participants. Alternatively, if the host has not logged in to start the session, no other participants will be allowed to log in, as indicated by 2012. Flow is then back to 2006 to continue checking for the host login.

The browser interface can be used when more console control is desired over the call, such as viewing who is participating in the call and how each participant has been in the session and the how long the session has been in existence. A feature called “Hosted Meet Me” helps prevent potential overuse and misuse of single conferencing PINs. It also prevents the conference call from remaining “open” after the host hangs up. Hosted Meet Me is ideal for large companies that distribute thousands of conferencing PINs to managers, and for university virtual classrooms where the call cannot start until the professor dials in.

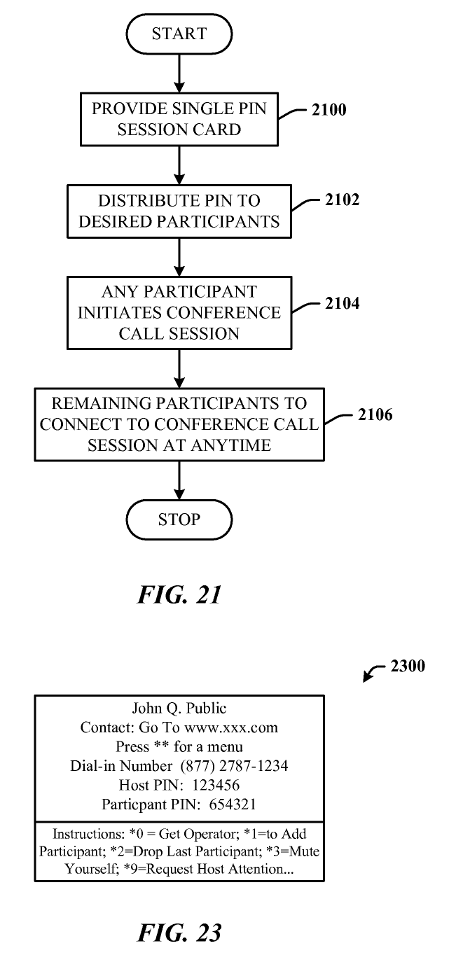

Referring now to FIG. 21, there is illustrated a methodology of managing a conference call session in a no-host (or non-hosted) manner in accordance with the invention. A single PIN “Meet Me” feature is also provided via the subject invention. This feature issues an active PIN number that can be distributed to any person desired to be in a conference. No Host PIN is created, so whenever any one of these participants calls in, a conference call session can begin with any of the other people who received that PIN. This single PIN Meet Me feature is desirable in many situations where a group of people need equal ability for any of them to start a conference call, such as among an engineering team.

Accordingly, at 2100, a single PIN session number is provided, in the form of, for example, a card. At 2102, the PIN is distributed to potential conference participants. It is to be appreciated that the PIN can be provided by many other conventional means, for example, e-mail, telephone call, messaging to a messaging device, and so on. At 2104, any person who has the PIN can dial-in to start the conference call session. At 2106, the remaining participants can call to connect to the session at any time.

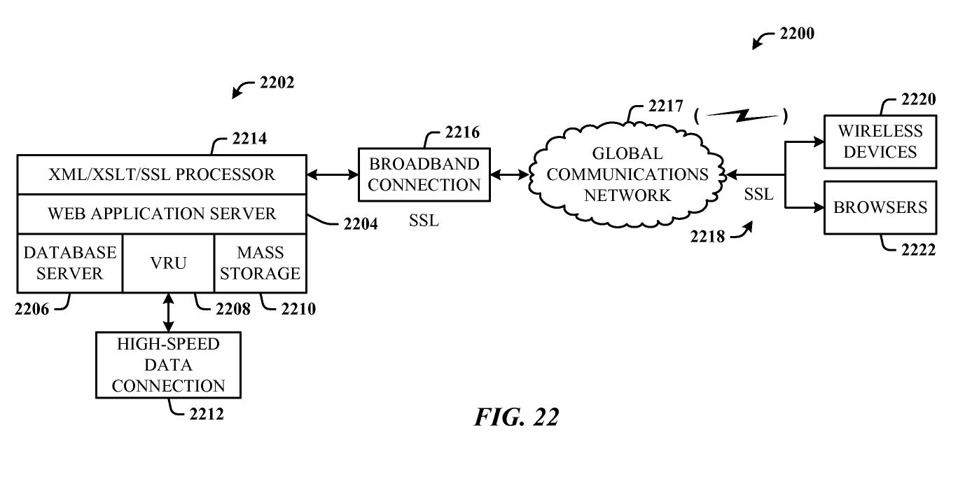

Referring now to FIG. 22, there is illustrated a general system configuration 2200 of the invention. The system 2200 includes a platform 2202 that hosts at least the data management tool, here called a web application server 2204. The server 2204 provides a common layer to underlying services that include a database server 2206, a VRU (voice response unit) 2208 (also called an interactive VRU or IVRU, and similar to the system 900 of FIG. 9 and system 1100 of FIG. 11) and mass storage system 2210. The VRU 2208 facilitates interactive calling features for a user via remote touch-tone signals and/or speech recognition facilities and to voice data to the caller such that the caller can make choices in response to predetermined options presented by the system.

The platform 2202 can utilize at least one multi-channel data communication connection 2212 (e.g., T1, DS3) into the VRU subsystem 2208 for communicating voice information and interacting with features of the platform 2202. As indicated previously, the invention can accommodate user communication from virtually any accessible network node. To facilitate such an interface, the platform 2202 can include a processor 2214 suitable for XML (eXtensible Markup Language), XSLT (XML Stylesheet Language: Transformations), and SSL processing. The processor 2214 can also access web-based services utilizing SOAP (Simple Object Access Protocol). SOAP employs XML syntax to send text commands across the network using HTTP (HyperText Transport Protocol). Thus, there is a high-speed connection 2216 (e.g., broadband) that interfaces to the processor layer 2214 for use with multiple communication exchanges with remote users disposed on a global communication network 2217. The remote users can access the platform system 2202 via a SSL or other secure connection 2218 using portable wired/wireless devices 2220, and by way of the associated browsers 2222.

The VRU subsystem 2208 also facilitates the recording of voice messages (e.g., voice mail) for access and retrieval at a later time. Additionally, the message is not restricted to access by a single user, but can be accessed by multiples users who are given the access authority (e.g., a PIN for a conference call session). The voice messages can be retrieved and presented via any number of different methods. For example, a user can access the voice message via a cell phone, VoIP phone, IP phone, a computer or computing device (e.g., desktop, laptop, tablet PC, PDA, and so on) by connecting to the system and providing sufficient credentials to access the message(s).

FIG. 23 illustrates a sample PIN card 2300 that can be used to access a conference call in accordance with the invention. The card 2300 includes access information in the format of a URL (uniform resource locator) address that can be used to enter into a conference call as a participant (using the participant PIN) or the host (using the host PIN). Other selections allow the caller to connect to an operator, access an options menu, add a participant, increase volume, drop the last participant, record a session, mute yourself, decrease volume, and unmute/request host attention, for example.

Communications between the CTI 912 and the session component 908 of FIG. 9, which together can be considered the VRU 2208 of FIG. 22, can be accomplished using many different programming codes. The code can facilitate a typical dial in process, entering of a PIN number, putting oneself on mute, and adding a participant using a DTMF (dual-tone multi-frequency) response of *1, for example. Both people then hang up.

This first section involves the VRU detecting and receiving an incoming call, and then sending a message to a SCP (Service Control Point). SCP is an SS7 (Signal System 7) signaling point containing a centralized database or enhanced service application. SS7 is an out-of-band signaling system that provides fast call setup (using circuit-switched connections) and transaction capabilities for remote database interactions. For example, toll-free number translation databases, or a HLR (home location register) and a VLR (visitor location register) databases in wireless networks. Once the user has input a PIN code, the SCP is contacted.

In one implementation, the VRU detects and receives an incoming call, and then sends a message to a SCP (service control point). SCP is an SS7 (Signaling System 7) signaling point containing a centralized database or enhanced service application. SS7 is an out-of-band signaling system that provides fast call setup (using circuit-switched connections), and transaction capabilities for remote database interactions, such as for example, toll-free number translation databases, a HLR (home location register) and/or VLR (visitor location register) databases in wireless networks. Once the user has input a PIN code, the SCP is contacted. Continuing with a generalized description of one SCP-related implementation, next, the PIN code is validated using the SCP, and the connection is accepted. A conference call session is created, a voice file can be played, and a participant added to the conference call session. DSP resources are also managed to allocate ports for the calls. The conference call session can be configured by the session host. A session participant can be called in preparation for entry into the conference call session, the, a caller can be added to the conference call session, a session participant removed from the current conference call session, and the conference call session terminated. In another implementation, the VRU does not send messaging via an SCP unit, but utilizes other means.

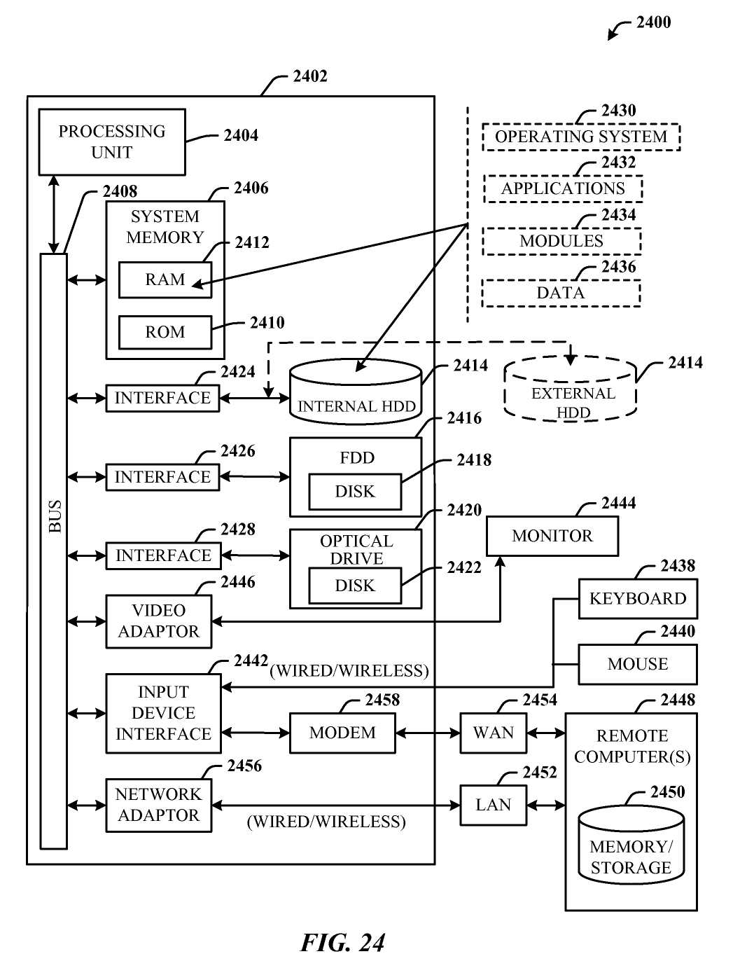

Referring now to FIG. 24, there is illustrated a block diagram of a computer 2402 operable to support the call management and/or professional services systems of the disclosed architecture. In order to provide additional context for various aspects of the subject invention, FIG. 24 and the following discussion are intended to provide a brief, general description of a suitable computing environment 2400 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 24, there is illustrated an exemplary environment 2400 for implementing various aspects of the invention that includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors. Dual microprocessors and other multi-processor architectures may also be employed as the processing unit 2404.

The system bus 2408 can be any of several types of bus structure that may further interconnect to a memory bus (with or without a memory controller), a peripheral bus, and a local bus using any of a variety of commercially available bus architectures. The system memory 2406 includes read only memory (ROM) 2410 and random access memory (RAM) 2412. A basic input/output system (BIOS) is stored in a non-volatile memory 2410 such as ROM, EPROM, EEPROM, which BIOS contains the basic routines that help to transfer information between elements within the computer 2402, such as during start-up. The RAM 2412 can also include a high-speed RAM such as static RAM for caching data.

The computer 2402 further includes an internal hard disk drive (HDD) 2414 (e.g., EIDE, SATA), which internal hard disk drive 2414 may also be configured for external use in a suitable chassis (not shown), a magnetic floppy disk drive (FDD) 2416, (e.g., to read from or write to a removable diskette 2418) and an optical disk drive 2420, (e.g., reading a CD-ROM disk 2422 or, to read from or write to other high capacity optical media such as the DVD). The hard disk drive 2414, magnetic disk drive 2416 and optical disk drive 2420 can be connected to the system bus 2408 by a hard disk drive interface 2424, a magnetic disk drive interface 2426 and an optical drive interface 2428, respectively. The interface 2424 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 2402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. It is appreciated that the invention can be implemented with various commercially available operating systems or combinations of operating systems.

A user can enter commands and information into the computer 2402 through one or more wired/wireless input devices, for example, a keyboard 2438 and a pointing device, such as a mouse 2440. Other input devices (not shown) may include a microphone, an IR remote control, a joystick, a game pad, a stylus pen, touch screen, or the like. These and other input devices are often connected to the processing unit 2404 through an input device interface 2442 that is coupled to the system bus 2408, but can be connected by other interfaces, such as a parallel port, an IEEE 1394 serial port, a game port, a USB port, an IR interface, etc.

A monitor 2444 or other type of display device is also connected to the system bus 2408 via an interface, such as a video adapter 2446. In addition to the monitor 2444, a computer typically includes other peripheral output devices (not shown), such as speakers, printers, etc.

The computer 2402 may operate in a networked environment using logical connections via wired and/or wireless communications to one or more remote computers, such as a remote computer(s) 2448. The remote computer(s) 2448 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory storage device 2450 is illustrated. The logical connections depicted include wired/wireless connectivity to a local area network (LAN) 2452 and/or larger networks, for example, a wide area network (WAN) 2454. Such LAN and WAN networking environments are commonplace in offices, and companies, and facilitate enterprise-wide computer networks, such as intranets, all of which may connect to a global communications network such as the Internet.

When used in a LAN networking environment, the computer 2402 is connected to the local network 2452 through a wired and/or wireless communication network interface or adapter 2456. The adaptor 2456 may facilitate wired or wireless communication to the LAN 2452, which may also include a wireless access point disposed thereon for communicating with the wireless adaptor 2456.

When used in a WAN networking environment, the computer 2402 can include a modem 2458, or is connected to a communications server on the WAN 2454, or has other means for establishing communications over the WAN 2454, such as by way of the Internet. The modem 2458, which can be internal or external and a wired or wireless device, is connected to the system bus 2408 via the serial port interface 2442. In a networked environment, program modules depicted relative to the computer 2402, or portions thereof, can be stored in the remote memory/storage device 2450. It will be appreciated that the network connections shown are exemplary and other means of establishing a communications link between the computers can be used.

The computer 2402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

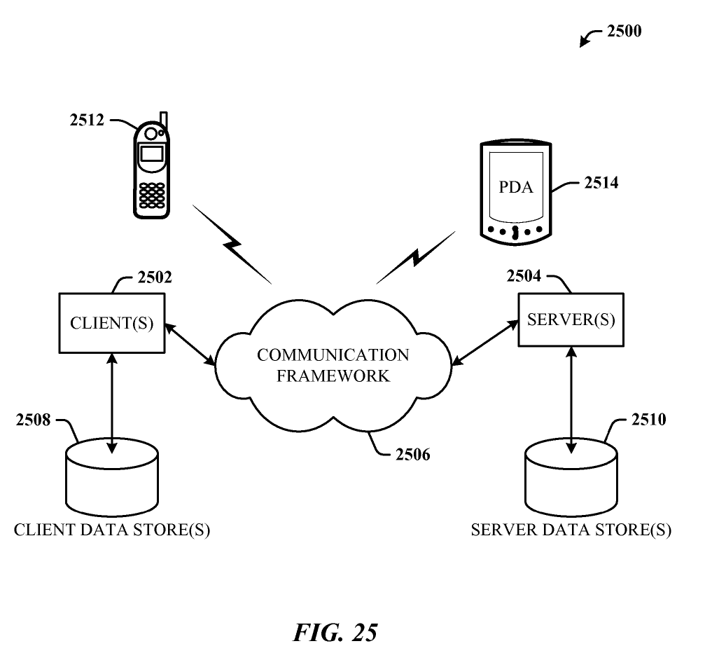

Referring now to FIG. 25, there is illustrated a schematic block diagram of an exemplary computing environment 2500 in accordance with the subject invention. The system 2500 includes one or more client(s) 2502. The client(s) 2502 can be hardware and/or software (e.g., threads, processes, computing devices). The client(s) 2502 can house cookie(s) and/or associated contextual information by employing the invention, for example.

The system 2500 also includes one or more server(s) 2504. The server(s) 2504 can also be hardware and/or software (e.g., threads, processes, computing devices). The servers 2504 can house threads to perform transformations by employing the invention, for example. One possible communication between a client 2502 and a server 2504 can be in the form of a data packet adapted to be transmitted between two or more computer processes. The data packet may include a cookie and/or associated contextual information, for example. The system 2500 includes a communication framework 2506 (e.g., a global communication network such as the Internet) that can be employed to facilitate communications between the client(s) 2502 and the server(s) 2504.

Communications can be facilitated via a wired (including optical fiber) and/or wireless technology. The client(s) 2502 are operatively connected to one or more client data store(s) 2508 that can be employed to store information local to the client(s) 2502 (e.g., cookie(s) and/or associated contextual information). Similarly, the server(s) 2504 are operatively connected to one or more server data store(s) 2510 that can be employed to store information local to the servers 2504. Devices such as a cellular telephone 2512 and a PDA 2514 can connect and/or participate in a call conferencing session.

Note that the architecture of the subject invention is not limited to call (or voice) conferencing, but also includes the capability of vide conferencing such that images are transmitted and presented to participants before, during, and/or after the session.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented call management system, comprising:
a professional services communications component of a professional services environment for processing a call; and
a web-based call communications component for interacting with the professional services communications component, processing call information of the services communications component, and providing call communications for a user of the professional services environment.

2. The system of claim 1, wherein the professional services communications component automatically links to the web-based call communications component in response to the user inputting a call code.

3. The system of claim 2, wherein the call code is input via a DTMF signal and, associated with an asterisk character and a number or a speed dial number.

4. The system of claim 1, wherein the call communications component initiates a conference call session at a predetermined time by automatically calling session participants and binding the session participants into the conference call session.

5. The system of claim 4, wherein the session participants participate in the conference call session via at least one of a cell phone, a messaging device, a computing device, or a VoIP phone.

6. The system of claim 4, wherein the web-based call communications component facilitates communications with a push-to-talk handset in the call session.

7. The system of claim 1, wherein the web-based call communications component automatically records the call session for download by one or more participants of the call session.

8. The system of claim 1, wherein the call communications component automatically sends an invoice of call charges to the services communications component based on predetermined period of time.

9. A computer-implemented method of call management, comprising:
entering a call code into a corporate phone system or voice recording a call code to initiate a call by a caller;
connecting the call from the corporate phone system to a web-based call management system based on the call code; and
routing the call to a call session via the web-based call management system.

10. The method of claim 9, further comprising prompting a caller of the call for an account number.

11. The method of claim 9, further comprising charging a caller account based on call characteristics that include duration of the call.

12. The method of claim 9, further comprising inputting an account number of a client and automatically charging the client for the call based on the account number.

13. The method of claim 9, further comprising initiating the call via an IP-based communications device.

14. The method of claim 9, further comprising prompting the caller with a voice-based recording to confirm call information and processing a voice-based caller response.

15. The method of claim 9, further comprising binding the call into the call session of which the recipient is a participant, the call session is a conference call session.

16. The method of claim 9, further comprising accessing operator assistance during the call session.

17. The method of claim 9, further comprising automatically communicating call session charges from the web-based call management system to a corporate back-office system after the call session has terminated.

18. The method of claim 9, further comprising dynamically allocating ports at the web-based call management system for the call session based on the call code.

19. The method of claim 9, further comprising automatically changing a level of service for a customer based on past usage.

20. A computer-implemented system, comprising:
computer-implemented means for receiving a call code from a business user into a corporate phone system to initiate a call to an external call session;
computer-implemented means for automatically routing the call from the corporate phone system to a web-based call management system based on the call code;
computer-implemented means for routing the call to the call session via the web-based call management system;
computer-implemented means for binding the call into the call session; and
computer-implemented means for tracking session activities and invoicing a client account of the corporation.
